(19) United States
(12) Patent Application Publication
(10) Pub. No.: US 2012/0005928 A1
(43) Pub. Date: Jan. 12, 2012

(54) SEAT COVER

(76) Inventor: Glen ELLA, Matraville (AU)

(21) Appl. No.: 12/976,623

(22) Filed: Dec. 22, 2010

(30) Foreign Application Priority Data
Jul. 12, 2010 (AU) 2010 903 079

(51) Int. Cl. A47C 31/00; G09F 3/00; A47C 31/02

(52) U.S. Cl. 40/320; 297/228.1; 297/224

(57) ABSTRACT

A seat cover for a seat having a back rest and a bottom rest such as a standard seat at a sporting stadium, the seat cover being adapted to slip over the seat to protect a spectator when sitting on a wet or dirty seat and or to display a particular logo. The cover includes a body of sheet material having a front panel adapted to cover the front of the seat and a rear panel adapted to cover the rear of the seat, the front panel and the rear panel being joined so as to form a mouth which is adapted to slip over the back rest of the seat and around the bottom rest of the seat.

### TECHNICAL FIELD

This invention relates to covers for seats, such as seats in a grandstand at a sporting arena.

### BACKGROUND ART

It often happens that seats in a grandstand are subject to adverse weather conditions and in the case of rain, the seat may be wet at the time at which a spectator wishes to use the seat or is dirty or unhygienic. Hitherto, the spectator was obliged to wipe the seat with a handkerchief or any convenient material or rag but such water absorbent materials are not always readily available.

It is, therefore, an object of the invention to provide a cover for a seat that is waterproof and which can be easily placed in position on the seat.

### DISCLOSURE OF INVENTION

According to the present invention, there is provided a cover for a seat having a back rest and a bottom rest, the cover comprising a body of sheet material having a front panel adapted to cover the front of the seat and a rear panel adapted to cover the rear of the seat, wherein the front panel and the rear panel are joined so as to form a mouth which is adapted to be slipped over the back rest of the seat and around bottom rest of the seat.

In a preferred form of the present invention, the mouth of the cover incorporates elastic material, so as to hold the cover on the bottom rest of the seat.

It is also preferred that at least a portion of the front panel of the waterproof sheet material incorporates padding so as to cushion the user on the seat.

Preferably, the sheet material is waterproof and comprises an outer waterproof layer and an inner absorbent layer adapted to absorb any moisture on the seat.

In a preferred form of the invention the waterproof sheet material has a logo printed thereon or attached thereto.

### BRIEF DESCRIPTION OF THE DRAWINGS

FIG. 1 is a perspective view of a seat cover in use, according to a preferred embodiment of the present invention;

FIG. 2 is a perspective view of a seat for use with the cover of FIG. 1;

FIG. 3 is a side view of a back panel of the cover of FIG. 1;

FIG. 4 is a side view of the back panel of FIG. 3, with an elastic band sewed therein;

FIG. 5 is a side view of the front panel of the cover of FIG. 1;

FIG. 6 is a side view of the back panel sewed onto the front panel of FIG. 5;

FIG. 7 is a side view of the cover of FIG. 6 with segments removed from its sides;

FIG. 8 is a close up view of the side of the cover of FIG. 6, with the segment removed;

FIG. 9 is a close up view of the side of the cover of FIG. 6, with the segment folded;

FIG. 10 is a close up view of the side of the cover of FIG. 6, with the segment sewn;

FIG. 11 is a side view of the cover of FIG. 1, at an intermediate stage of production;

FIG. 12 is a side view of the cover of FIG. 1, at a final stage of production;

FIG. 13 is a side view of the cover of FIG. 1, about to be installed on a seat; and

FIG. 14 is a perspective view of the bottom of the seat of FIG. 2, with the cover of FIG. 1 installed thereon.

### BEST MODE FOR CARRYING OUT THE INVENTION

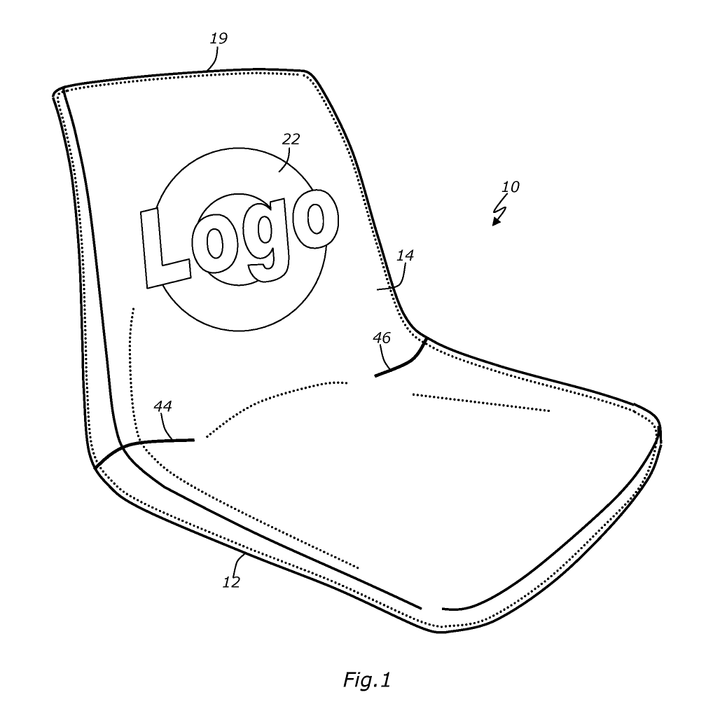

The seat cover 10 shown in FIG. 1 is, in essence, a cover that slips over a standard seat at any sporting stadium to protect the spectator when sitting on a wet or dirty seat or to display a particular logo. The cover 10 includes a body of sheet material 12 having a front panel 14 and a rear panel 16. The sheet material may be waterproof.

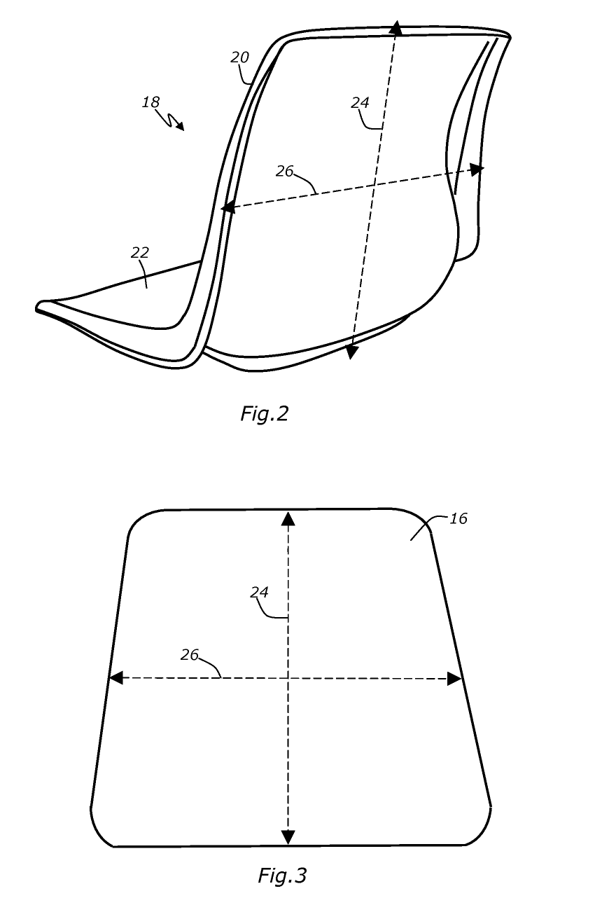

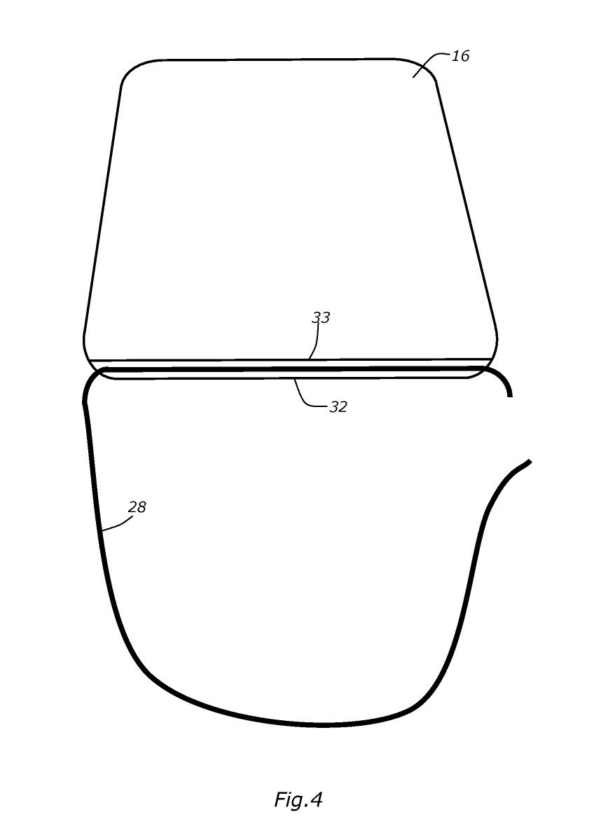

A seat 18 for use with the cover 10 is shown in FIG. 2. The seat 18 has a back rest 20 and a bottom rest 22. The rear panel 16 of the material 12 (see FIG. 3) must be cut to approximately match a height 24 and width 26 of the back rest 20 of the seat 18. A bottom edge 32 of the rear panel 16 is folded (along fold line 33) and sewed over an elastic band 28 so as to hold the elastic band 36 within it (see FIG. 4).

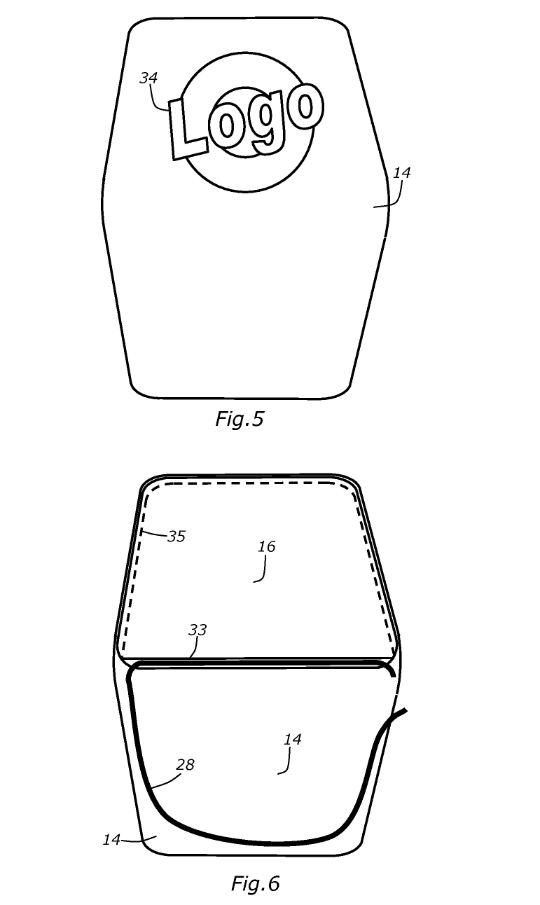

If the back rest 20 is approximately equal in size to the bottom rest 22 of the seat 18, then the front panel 14 should be cut to approximately double the size of the rear panel 16 of the material 12 (see FIG. 5). The material 12 may be produced in team colours with a team logo 34 so that the cover 10 doubles as a supporter's item that allows the spectator to demonstrate the team they are supporting. The material 12 may comprise an outer waterproof layer and an inner absorbent layer adapted to absorb any moisture on the seat.

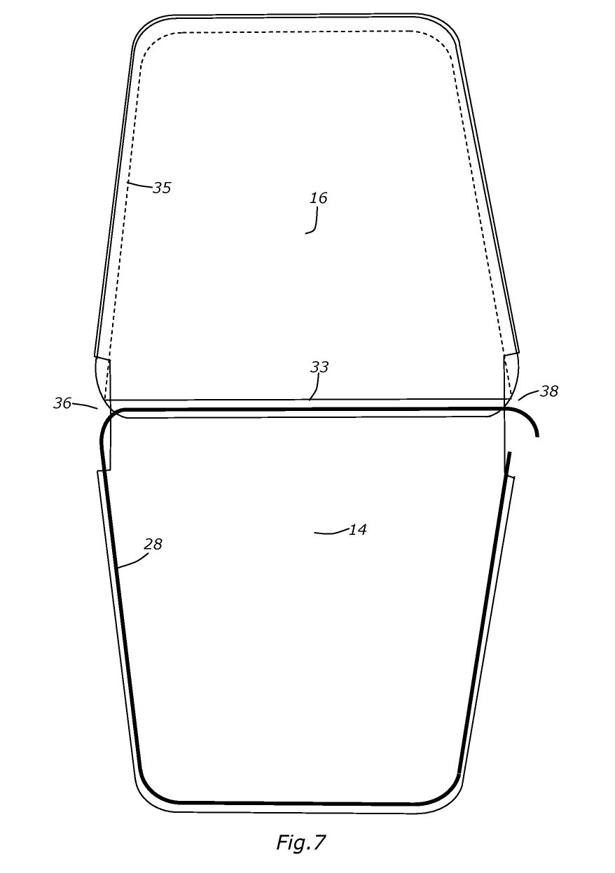

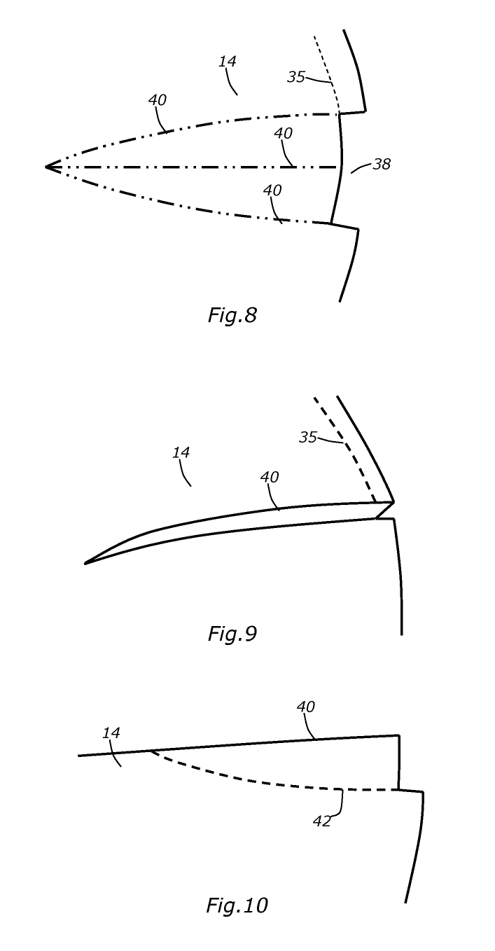

As shown in FIG. 6, the rear panel 16 is sewed to side of the front panel 14 having the logo 34 (indicated by sewing lines 35). Segments of the front panel 14 are removed (see FIG. 7) leaving recesses 36 and 38. Segment 38 is shown in FIG. 8, wherein the front panel 14 is folded along lines 40 and then pinched together (see FIG. 9). The top section of the front panel 14 is then folded downward and sewn along sew line 42 (see FIG. 10). The same process is repeated for segment 36. The sew line 42 (and its counterpart for segment 36) form the crease lines 44 and 46 on the cover 10, which are shown in FIG. 1.

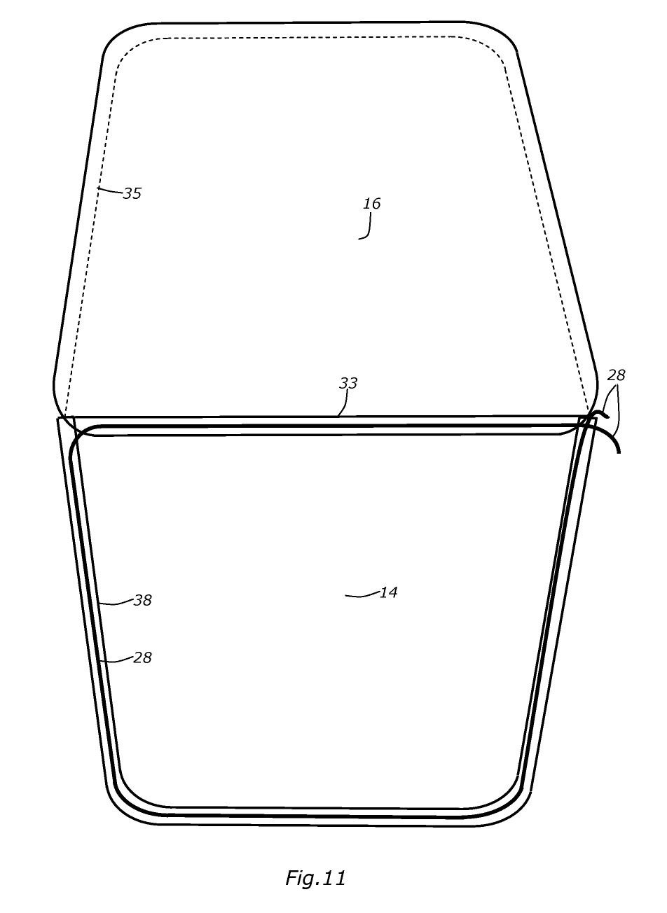

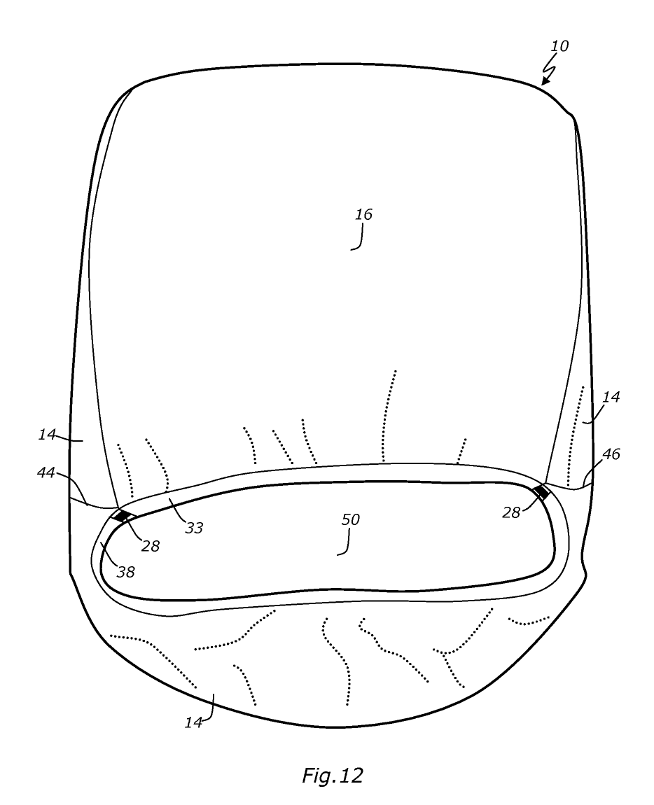

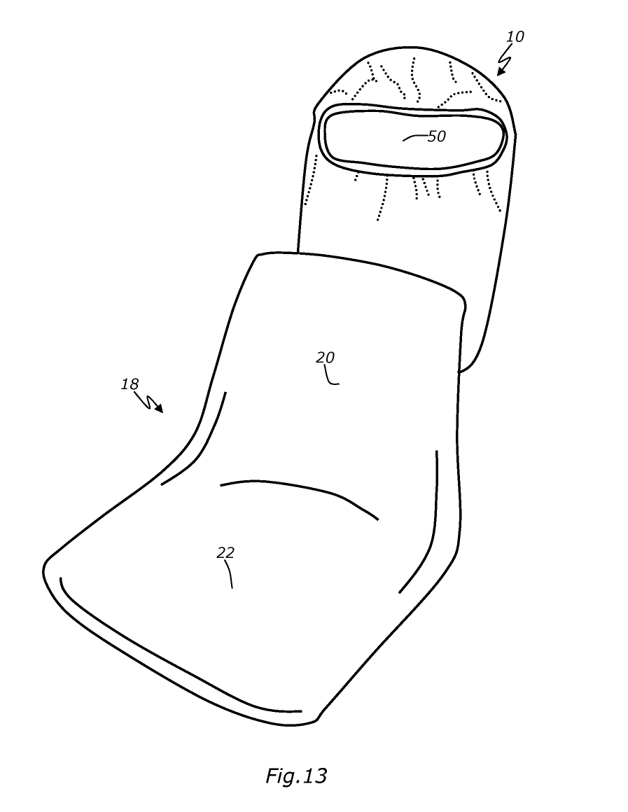

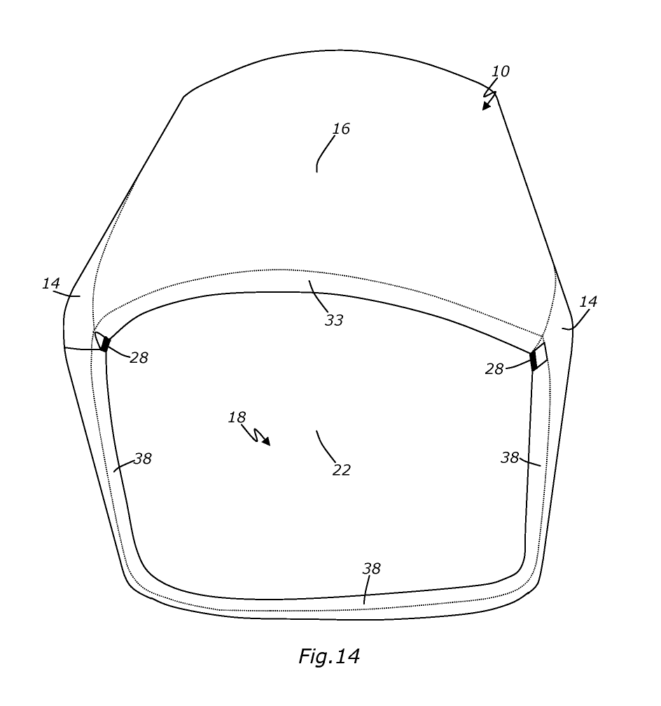

As shown in FIG. 11, an edge 48 of the front panel 14 is folded over and sewn with the elastic band 28 located therein. The two ends of the elastic band 28 are then pulled and sewn to each other, so as to form a mouth 50 (see FIG. 12). The cover 10 is turned inside out through the mouth 50 so that all stitching is located inside the cover 10 and not visible to a user. The mouth 50 forms a pocket which may be inserted over the back rest 20 of the seat 18 (see FIG. 13) and over the rim of bottom rest 22 of the seat 18 (see FIG. 14).

The panel of the cover 10 which covers the bottom rest 22 of the seat 18 may be lightly padded to provide the user with some comfort when sitting on a hard seat at a sporting event. The cover 10 may be disposable after use so that the spectator does not have the hassle of carrying the cover 10 home or to have to worry about what to do with it if going out after the sporting event.

1. A cover for a seat having a back rest and a bottom rest, the cover comprising a body of sheet material having a front panel adapted to cover the front of the seat and a rear panel adapted to cover the rear of the seat, wherein the front panel and the rear panel are joined so as to form a mouth which is adapted to be slipped over the back rest of the seat and around bottom rest of the seat.

2. A cover for a seat according to claim 1 wherein the mouth of the cover incorporates elastic material, so as to hold the cover on the bottom rest of the seat.

3. A cover for a seat according to claim 1 wherein at least a portion of the front panel of the waterproof sheet material incorporates padding so as to cushion the user on the seat.

4. A cover for a seat according to claim 1 wherein the sheet material is waterproof and comprises an outer waterproof layer and an inner absorbent layer adapted to absorb any moisture on the seat.

5. A cover for a seat according to claim 4 wherein the waterproof sheet material has a logo printed thereon or attached thereto.
